(19) United States
(12) Patent Application Publication
(10) Pub. No.: US 2011/0141017 A1
(43) Pub. Date: Jun. 16, 2011

(54) Waterproof mouse

(76) Inventor: Allen Ku, Walnut, CA (US)

(21) Appl. No.: 12/654,131

(22) Filed: Dec. 11, 2009

(51) Int. Cl. G06F 3/033

(52) U.S. Cl. 345/163

(57) ABSTRACT

A waterproof mouse includes a casing assembly, a circuit board, two touch switches, and a capacitive touch panel. The casing assembly has a base and a cover that are assembled with each other. A soft ring is assembled between the base and the cover. An outer cover with an opening covers on the cover, forms two elastic pressing portions and provides two protruding posts penetrating the cover into the base. The circuit board is provided in the base. The touch switches are coupled to the circuit board respectively and correspond to the two protruding posts of the outer cover. The capacitive touch panel, coupled to the circuit board, is assembled with the cover and located in the opening of the outer cover. With the above structure, the liquid penetrated into the mouse can be prevented. Further, in virtue of the capacitive touch panel, the mouse has a unique practicability.

### BACKGROUND OF THE INVENTION

1. Field of the Invention

The present invention relates to a mouse, and in particular to a waterproof mouse, on which a touch panel is provided to replace a roller for scrolling an image displayed on a screen.

2. Description of Related Art

As for input devices of the current personal computer or notebook, keyboard and mouse are most popular. The mouse is used to replace the directional keys on the keyboard, thereby acting as an input device for moving a cursor and pointing to desired locations. Thus, in an operating system of a computer, the mouse is an important peripheral device because the mouse can make a user easier to execute various application programs.

The current mice in the market are classified into wired mice and wireless mice. No matter which kind it is, a roller is provided at a front end of the mouse. With the rolling of the roller, an internal mechanical encoder or an optical gate can be driven to scroll upwards or downwards an image on a display screen. The roller is provided in an opening at the front and top portion of the casing of the mouse. The top of the roller protrudes from the casing, so that the finger of a user can poke the roller to control the operation of the mouse.

However, the mouse is almost used on a working surface such as a table. When the user splashes water carelessly on the mouse, the water droplets may penetrate into the mouse through the opening at which the roller is provided. Further, the water droplets may penetrate into the gap of the casing to make internal electronic elements to suffer damage. Thus, it is important to develop a waterproof mouse for preventing the penetration of liquid into the mouse and having a unique practicability.

In order to overcome the above problems, the present Inventor proposes a novel and reasonable structure based on his delicate researches and expert experiences.

### SUMMARY OF THE INVENTION

An objective of the present invention is to provide a waterproof mouse, whereby the penetration of liquid into the mouse through the top and sides of the casing can be prevented. Further, the mouse of the present invention has a unique practicability, so that it can be distinguishable from the conventional mouse.

To achieve the above objectives, the present invention provides a waterproof mouse, which includes a casing assembly, a circuit board, two touch switches, and a capacitive touch panel.

The casing assembly has a base, a cover, an outer cover and a soft ring. The base is assembled with the cover. The soft ring is assembled between the base and the cover to both touch the base and the cover. The outer cover is provided with an opening and formed with two elastic pressing portions. The outer cover covers on the cover. The inner bottom surface of the outer cover is provided with two protruding posts extending through the cover into the base.

The circuit board is provided in the base. The touch switches are coupled to the circuit board respectively and correspond to the two protruding posts of the outer cover. The capacitive touch panel is assembled with the cover and located in the opening of the outer cover. The capacitive touch panel is disposed between the two pressing portions and coupled to the circuit board.

The present invention has advantageous features as follows. The capacitive touch panel is used to replace the roller on the conventional mouse. Further, the outer cover covers on the cover, and the soft ring is assembled between the cover and the base. In this way, the gap in the casing of the mouse can be reduced. With the above structure, the penetration of liquid into the mouse through the top and sides of the casing can be prevented. Further, in virtue of the capacitive touch panel, the mouse of the present invention has a unique practicability, so that it can be distinguishable from the conventional mouse.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is an assembled perspective view according to a first embodiment of the present invention;

FIG. 2 is an exploded perspective view according to the first embodiment of the present invention;

FIG. 3 is an exploded perspective view according to the first embodiment of the present invention along another viewing angle;

FIG. 4 is a partially exploded perspective view according to the first embodiment of the present invention;

FIG. 5 is an assembled perspective view according to a second embodiment of the present invention;

FIG. 6 is an exploded perspective view according to the second embodiment of the present invention; and

FIG. 7 is an exploded perspective view according to the second embodiment of the present invention from another viewing angle.

### DETAILED DESCRIPTION OF THE PREFERRED EMBODIMENTS

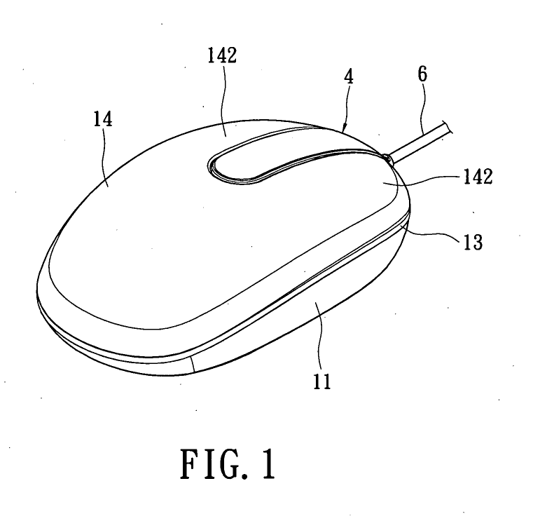

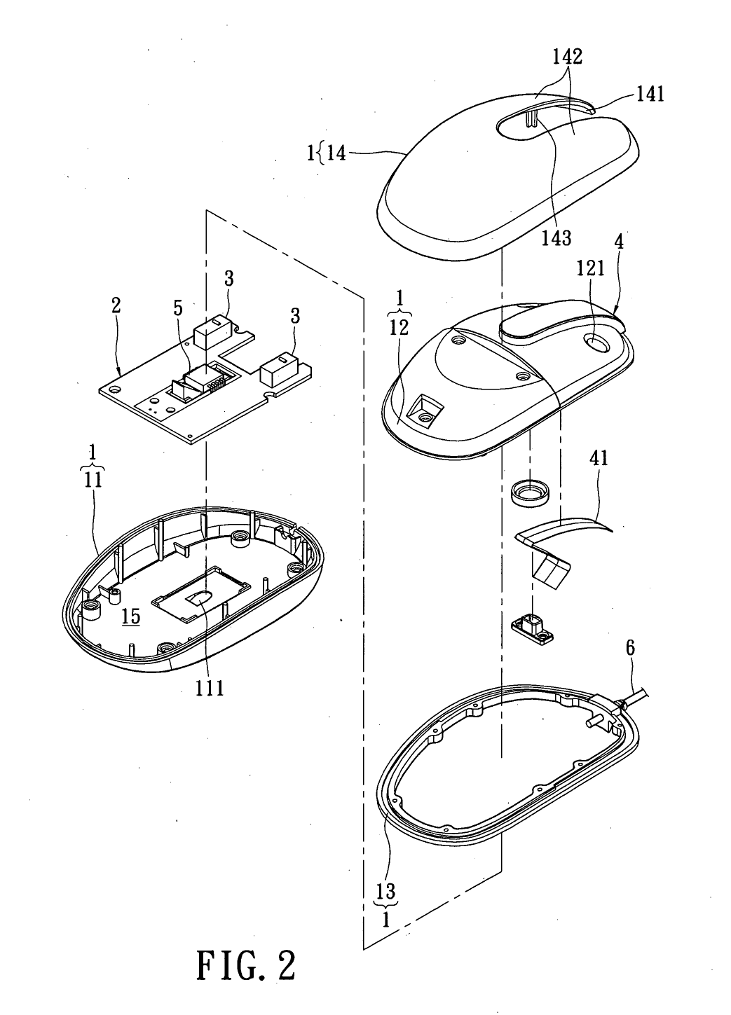

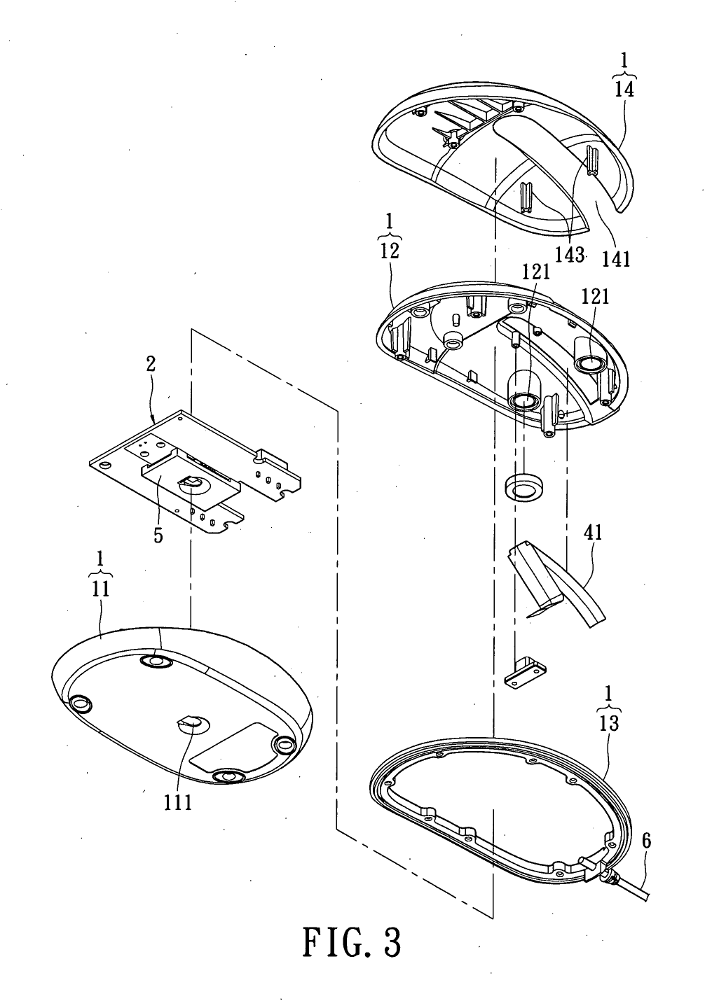

Please refer to FIGS. 1 to 3. The present invention provides a waterproof mouse, which includes a casing assembly 1, a circuit board 2, two touch switches 3 and a capacitive touch panel 4.

The casing assembly 1 has a base 11, a cover 12, a soft ring 13, and an outer cover 14. The base 11 is assembled with the cover 12 to form an accommodating space 15 there between. The cover 12 is provided with two perforations 121. The bottom of the base 11 is provided with a through-hole 111.

The soft ring 13 is an annular body made of soft materials such as rubber or silicon. The soft ring 13 is assembled between the base 11 and the cover 12, thereby both touching the base 11 and the cover 12. The outer cover 14 is provided with an opening 141 and formed with two elastic pressing portions 142. The opening 141 is formed on the outer cover 14 in such a manner that it recesses rearwards from the front end of the outer cover 14. Further, the inner bottom surface of the pressing portion 142 of the outer cover 14 protrudes downwards to form two protruding posts 143.

The circuit board 2 is received in the base 11 and located in the accommodating space 15. The touch switches 3 are coupled to the circuit board 2 respectively. The touch switches 3 are disposed on the circuit board 2 at an interval in the accommodating space 15. Further, the circuit board 2 is coupled to a cursor control unit 5 in the accommodating space 15 to correspond to the through-hole 111 of the base 11. The type of cursor control unit 5 may be an optical type or a mechanical type, and the optical cursor control unit is preferred for optical sensing a displacement of light source passing and reflecting via the through-hole 111.

The capacitive touch panel 4 is assembled on the cover 12. Further, the capacitive touch panel 4 is coupled to the circuit board 2 by means of a flexible circuit board 41 connected to the circuit board 2.

The outer cover 14 covers on the cover 12, so that the capacitive touch panel 4 is located in the opening 141 of the outer cover 14 between the two pressing portions 142. At the same time, the protruding posts 143 of the outer cover 14 pass through the cover 12 into the base 11. Thus, the protruding posts 143 extend into the accommodating space 15 to correspond to the touch switches 3. With this arrangement, when the pressing portions 142 are pressed, the protruding posts 143 will be brought into contact with the touch switches 3 to generate a predetermined signal (like the left and right keys of the mouse). More specifically, the protruding posts 143 pass through the perforations 121 of the cover 12 into the accommodating space 15 in such a manner that they are positioned to correspond to the touch switches 3.

With the above arrangement, the finger of a user can touch the capacitive touch panel 4 and slide thereon, thereby generating a signal to control the scrolling of an image displayed on a screen. That is to say, the capacitive touch panel 4 functions as the roller of the conventional mouse for scrolling an image displayed on the screen. At the same time, with the structure constituted of the outer cover 14, the cover 12 and the soft ring 13, the outer cover 14 covers on the cover 2, and the soft ring 13 fills the gap between the cover 12 and the base 11. Thus, the penetration of liquid L (such as water) into the mouse can be prevented, so that the electronic elements inside the mouse can be protected from suffering damage.

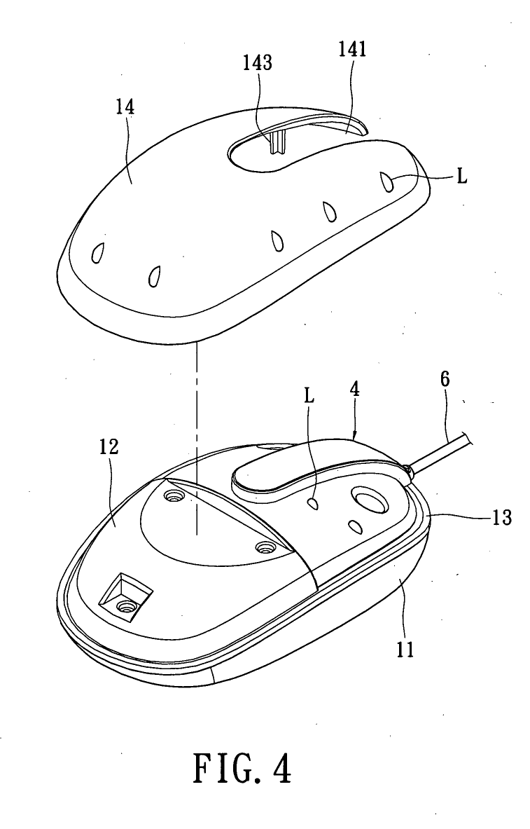

According to the above, as shown in FIG. 4, when the liquid L flows sideways along the profile of the outer cover 14, the penetration of liquid L into the mouse through the sides of the mouse can be prevented because the soft ring 13 fills the gap between the cover 12 and the base 11. At the same time, although the liquid L splashing on the capacitive touch panel 4 may flow on the cover 12 along its periphery, the liquid L will be blocked by the cover 12 and can only flow to the sides of the cover 12 along its profile. Thus, the direct penetration of liquid L into the mouse can be prevented completely.

Further, the mouse of the present invention can be a wired mouse or a wireless mouse. FIGS. 1 to 4 show a first embodiment of the present invention, which further includes a signal wire 6. The signal wire 6 passes through the base 11 to be connected with the circuit board 2, thereby forming a wired mouse.

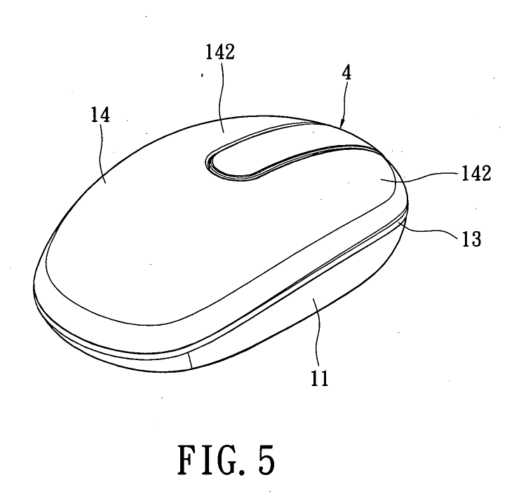

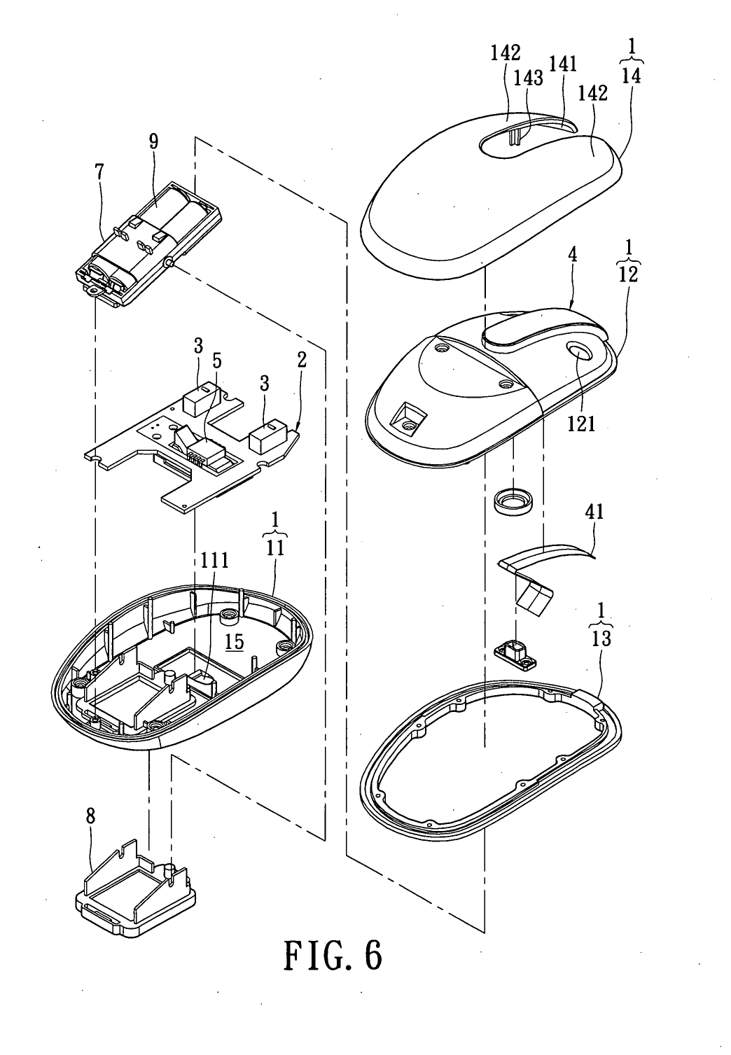

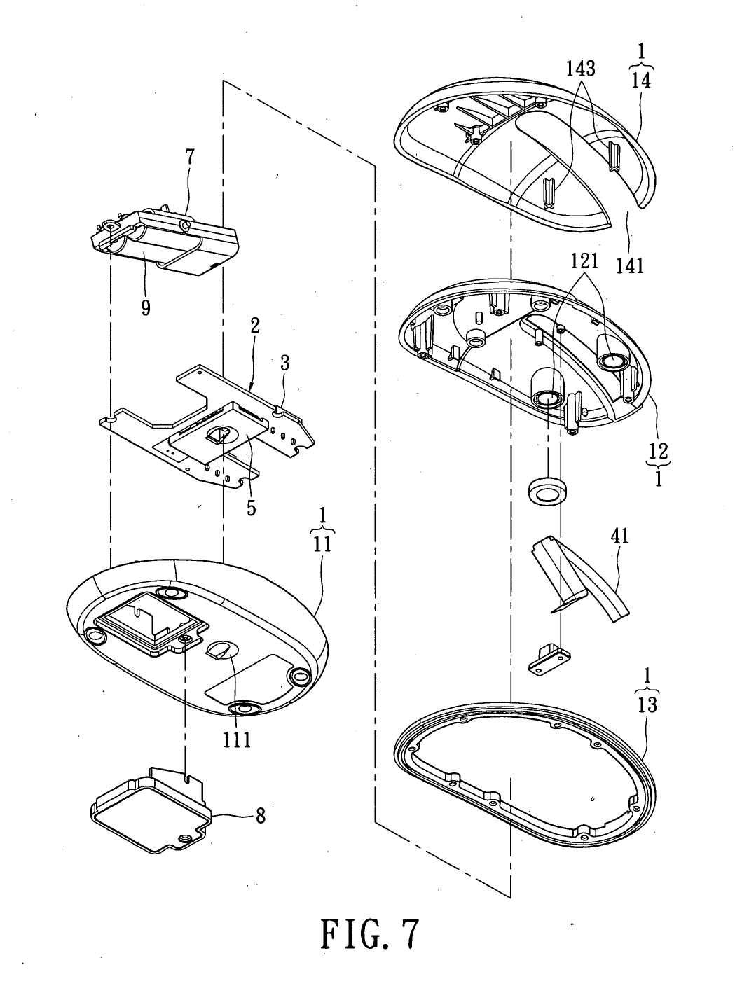

FIGS. 5 to 7 show a second embodiment of the present invention, which is a wireless mouse further comprising a battery-receiving portion 7 and a battery seat 8. The battery-receiving portion 7 is assembled on the battery seat 8. The battery seat 8 is inserted in one end of the circuit board 2. The battery-receiving portion 7 is coupled to the circuit board 2 with battery springs being soldered on the circuit board 2. However, the way of coupling the battery-receiving portion 7 to the circuit board 2 is not limited thereto. The battery-receiving portion 7 is used to receive batteries 9 therein for supplying electricity to the wireless mouse. The circuit board 2 is provided with a transmitter (not shown) for transmitting signals to a receiver (not shown) on a computer. In this way, the computer can receive the signals from the wireless mouse.

According to the above description, in the present invention, the capacitive touch panel 4 is used to replace the roller of the conventional mouse. Further, the outer cover 14 covers on the cover 12, and the soft ring 13 is disposed between the cover 12 and the base 11 to fill the gap of the casing. With this arrangement, the penetration of liquid into the mouse through the top and sides of the casing can be prevented. Further, in virtue of the capacitive touch panel 4, the present mouse indeed has a unique practicability and can be distinguishable from the conventional mouse.

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. A waterproof mouse, including:
a casing assembly having a base, a cover, an outer cover, and a soft ring, the base being assembled with the cover, the soft ring being assembled between the base and the cover to both touch the base and the cover, the outer cover being provided with an opening and formed with two elastic pressing portions, the outer cover covering on the cover, and an inner bottom surface of each pressing portion of the outer cover being provided with a protruding post penetrating the cover into the base;
a circuit board provided in the base;
two touch switches coupled to the circuit board respectively and corresponding to the two protruding posts of the outer cover; and
a capacitive touch panel, coupled to the circuit board, assembled with the cover and located in the opening of the outer cover between the two pressing portions.

2. The waterproof mouse according to claim 1, further comprising a signal wire penetrating the base to be connected to the circuit board.

3. The waterproof mouse according to claim 1, further comprising a battery-receiving portion and a battery seat, the battery-receiving portion being assembled on the battery seat, the battery seat being inserted into an end of the circuit board, and the battery-receiving portion being coupled to the circuit board.

4. The waterproof mouse according to claim 1, wherein the capacitive touch panel is connected to the circuit board through a flexible circuit board, thereby coupling to the circuit board.

5. The waterproof mouse according to claim 1, wherein an accommodating space is formed between the cover and the base, the circuit board and the touch switches are located in the accommodating space.

6. The waterproof mouse according to claim 1, wherein the cover is provided with two perforations, the protruding posts of the outer cover pass through the perforations of the cover into the accommodating space in such a manner that they are positioned to correspond to the touch switches.

7. The waterproof mouse according to claim 1, wherein the circuit board is further coupled to a cursor control unit located in the accommodating space, a bottom of the base is provided with a through-hole corresponding to the cursor control unit.
